(19) United States
(12) Patent Application Publication
(10) Pub. No.: US 2015/0282243 A1
(43) Pub. Date: Oct. 1, 2015

(54) METHODS AND APPARATUSES OF RADIO RESOURCE CONTROL CONNECTION RECOVERY

(71) Applicant: Nokia Technologies Oy, Espoo (FI)

(72) Inventors: Yixue Lei, Beijing (CN); Haitao Li, Beijing (CN); Ling Yu, Oulu (FI)

(21) Appl. No.: 14/434,820

(22) PCT Filed: Nov. 9, 2012
(86) PCT No.: PCT/CN2012/084352

§ 371 Date: Apr. 10, 2015

(51) Int. Cl. H04W 76/02; H04W 76/04; H04W 24/02

(52) U.S. Cl. CPC H04W 76/028; H04W 24/02; H04W 76/046

(57) ABSTRACT

A method and related user equipment for radio resource control connection recovery are disclosed. In an exemplary embodiment, the method comprises: detecting a RLF of a radio link between a first user equipment and a radio access node; informing a second user equipment which communicates with the radio access node via the first user equipment to suspend a radio resource control connection state; executing a radio resource control connection reestablishment procedure with the radio access node; and informing the second user equipment to resume the radio resource control connection state if the radio resource control connection reestablishment is successful. In addition, a method and related user equipment used with radio resource control connection recovery are disclosed.

### TECHNICAL FIELD OF THE INVENTION

The present invention relates to radio communication, and more particularly, to methods and apparatuses of radio resource control connection recovery due to radio link failure (RLF).

### BACKGROUND OF THE INVENTION

In a radio communication system, there may be a scenario in which one user equipment (UE) may rely on another user equipment to communicate with a radio access node. In such a scenario, the user equipment which relies on another user equipment may be referred to as “a relayed UE”, and the user equipment on which another user equipment relies may be referred to as “a relaying UE”. The relaying UE may support one or multiple relayed UEs and it then acts as an access point or cluster header for the relayed UEs to access a radio network.

FIG. 1 illustratively shows such scenario. As shown in FIG. 1, the relaying UE is under control of a radio access node, for example an eNodeB in a Long Term Evolution (LTE) communication network, and has a radio resource control (RRC) connection RRC-1 with the eNodeB. The RRC-1 is a direct RRC connection which is established over a LTE radio link. Moreover, the relaying UE can set up a device-to-device (D2D) radio link with the relayed UE. The relayed UE may not set up a direct RRC connection with the eNodeB. In order to utilize services provided through the eNodeB, the relayed UE may have an indirect RRC connection RRC-2 with the eNodeB via the relaying UE. The RRC-2 can be supported by two radio links, one is the D2D radio link between the relayed UE and the relaying UE, and the other is the LTE radio link between the relaying UE and the eNodeB. Thus the relayed UE can communicate with the eNodeB. The D2D radio link may be cellular based, such as LTE based, or non-cellular based, such as WiFi based.

FIG. 2 illustratively shows protocol stacks of the relayed UE, the relaying UE and the eNodeB. The relayed UE and the relaying UE can have both D2D protocol stack and LTE protocol stack, and the eNodeB has only LTE protocol stack. The RRC connection between the relaying UE and the eNodeB is established over the LTE radio link, and the RRC connection between the relayed UE and the eNodeB is established over the D2D radio link and the LTE radio link. The RRC signaling messages between the relayed UE and the eNodeB need to be transmitted between the relayed UE and the relaying UE over the D2D radio link and between the relaying UE and the eNodeB over the LTE radio link. For the D2D radio link, any kind of L1/L2/L3 protocols can be adopted, such as LTE or WiFi.

In the scenario shown as FIG. 1, when the LTE radio link fades or fails, how to recover the RRC connection efficiently is very important.

In the case that the RLF happens at the LTE radio link between the relaying UE and the eNodeB, the relaying UE may detect the RLF, and most probably the relayed UE may also detect the RLF. Both the relaying UE and the relayed UE may initiate the RRC connection recovery, and thus some problems will be caused.

Firstly, the relayed UE may initiate the RRC connection recovery when the RRC connection recovery is ongoing between the relaying UE and the eNodeB or even after the RRC connection recovery between the relaying UE and the eNodeB is successful. This will cause additional signaling cost and may cause service interruption as well. In addition, the RRC connection RRC-2 between the relayed UE and the eNodeB will be impacted by the RRC connection recovery between the relaying UE and the eNodeB, and the relayed UE may be suffered from certain latency. With another RRC connection recovery initiated by the relayed UE, the latency will become more serious. This will affect the service continuity and user experiences for the relayed UE. On the other hand, the execution of RRC connection recovery is logically between the relayed UE and the eNodeB, but physically over the two radio links: the D2D radio link and the LTE radio link. If the D2D radio link is based on WiFi, the latency may be notable. The increased latency due to the D2D radio links will be several times of the D2D radio link latency considering the number of signaling interactions.

Secondly, if the RRC connection recovery between the relaying UE and the eNodeB fails and the relayed UE is unaware of this, the relayed UE may still try to recover the RRC connection and definitely this recovery will fail. This will cause unnecessary signaling overhead and power consumption as well.

The existing RLF handling procedure can be illustrated in FIG. 3. As shown in FIG. 3, the procedure comprises two phases. Initially, the user equipment is in RRC_CONNECTED state with the eNodeB and under the normal operation. When the user equipment detects a radio problem of the radio link between the user equipment and the eNodeB, the procedure proceeds to First Phase and a first timer of T₁ is started. The user equipment may detect the radio problem by detecting whether signal quality over the radio link is lower than a predetermined threshold. In the First Phase, if the radio link is recovered before the first timer expires, no explicit signaling between the user equipment and the eNodeB is needed. However, if the radio link is not recovered before the first timer expires, the user equipment determines the RLF occurs, and the procedure proceeds to Second Phase. In the Second Phase, the user equipment starts a RRC connection reestablishment procedure with the eNodeB, and a second timer of T₂ is started. If the RRC connection is successfully reestablished between the user equipment and the eNodeB before the second timer expires, the user equipment continues communication with the eNodeB. If the RRC connection is not reestablished before the second timer expires, the user equipment will be transited into RRC_IDLE state and recover the RRC connection via idle mode procedure.

In the legacy RRC connection reestablishment procedure, the user equipment may send a RRC Connection Reestablishment Request to the eNodeB. Then the eNodeB may send a RRC Connection Reestablishment message to the user equipment to update related parameters of signaling radio bearers. Finally after all the parameters are updated successfully, the user equipment may send a RRC Connection Reestablishment Complete message to the eNodeB.

However, this legacy RRC connection reestablishment procedure is not applicable for the relayed UE in the scenario shown in FIG. 1. Firstly, the legacy RRC connection reestablishment procedure requires the user equipment to conduct cell reselection, but the relayed UE should reestablish its RRC connection to the eNodeB via the relaying UE, instead of reestablishing its RRC connection directly. Secondly, the legacy RRC connection reestablishment procedure relies on the user equipment's PHY layer to detect the radio problem over the LTE radio link, but there is no LTE radio link for the relayed UE. Thirdly, the legacy RRC connection reestablishment procedure is conducted between the user equipment and the eNodeB without impact or involvement of another user equipment, but the RRC connection reestablishment between the relayed UE and the eNodeB will involve the relaying UE. Meanwhile the RRC connection reestablishment between the relaying UE and the eNodeB will also impact the RRC connection between the relayed UE and the eNodeB.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

The present invention is directed to a method for radio resource control connection recovery, a method used with radio resource control connection recovery, and related user equipments.

According to one embodiment, a method for radio resource control connection recovery comprises: detecting a RLF of a radio link between a first user equipment and a radio access node; informing a second user equipment which communicates with the radio access node via the first user equipment to suspend a radio resource control connection state; executing a radio resource control connection reestablishment procedure with the radio access node; and informing the second user equipment to resume the radio resource control connection state if the radio resource control connection reestablishment is successful.

In an exemplary embodiment, the method may further comprise: informing the second user equipment of the radio resource control connection reestablishment failure if the radio resource control connection reestablishment fails.

In an exemplary embodiment, informing the second user equipment to suspend a radio link connection state may comprise: sending, to the second user equipment, a first message indicative of suspending timers and counters related to RLF.

In an exemplary embodiment, informing the second user equipment to resume the radio resource control connection state may comprise: sending, to the second user equipment, a second message indicative of resuming the suspended timers and counters.

In an exemplary embodiment, the radio link is a cellular radio link, and the first user equipment has a device-to-device radio link with the second user equipment.

In an exemplary embodiment, the device-to-device radio link is cellular based or non-cellular based.

According to another embodiment, a method used with radio resource control connection recovery by a second user equipment which communicates with a radio access node via a first user equipment comprises: receiving, from the first user equipment which has a radio link with the radio access node, a first message indicative of suspending a radio resource control connection state; suspending the radio resource control connection state; receiving, from the first user equipment, a second message indicative of resuming the radio resource control connection state or radio resource control connection reestablishment failure; and resuming the radio resource control connection state when the second message indicates resuming the radio resource control connection state.

In an exemplary embodiment, suspending the radio resource control connection state may comprise suspending timers and counters related to RLF.

In an exemplary embodiment, resuming the radio resource control connection state may comprise resuming the suspended timers and counters.

According to another embodiment, a method used with radio resource control connection recovery by a second user equipment which communicates with a radio access node via a first user equipment comprises: detecting a RLF of a radio link between the first user equipment and the radio access node; suspending initiation of radio resource control connection recovery; receiving, from the first user equipment, a message indicative of successful radio resource control connection reestablishment or failed radio resource control connection reestablishment; and resuming the detection of the RLF when the message indicates the successful radio resource control connection reestablishment.

In an exemplary embodiment, the method may further comprise: setting a suspension timer which defines a time period for suspension of the initiation of radio resource control connection recovery.

According to another embodiment, a first user equipment for radio resource control connection recovery comprises: at least one processor; and at least one memory including computer program code; the at least one memory and the computer program code configured to, with the at least one processor, cause the first user equipment to perform at least the following: detecting a RLF of a radio link between the first user equipment and a radio access node; informing a second user equipment which communicates with the radio access node via the first user equipment to suspend a radio resource control connection state; executing a radio resource control connection reestablishment procedure with the radio access node; and informing the second user equipment to resume the radio resource control connection state if the radio resource control connection reestablishment is successful.

According to another embodiment, a second user equipment used with radio resource control connection recovery, the second user equipment communicating with a radio access node via a first user equipment, comprises: at least one processor; and at least one memory including computer program code; the at least one memory and the computer program code configured to, with the at least one processor, cause the second user equipment to perform at least the following: receiving, from the first user equipment which has a radio link with the radio access node, a first message indicative of suspending a radio resource control connection state; suspending the radio resource control connection state; receiving, from the first user equipment, a second message indicative of resuming the radio resource control connection state or radio resource control connection reestablishment failure; and resuming the radio resource control connection state when the second message indicates resuming the radio resource control connection state.

According to another embodiment, a second user equipment used with radio resource control connection recovery, the second user equipment communicating with a radio access node via a first user equipment, comprises: at least one processor; and at least one memory including computer program code; the at least one memory and the computer program code configured to, with the at least one processor, cause the second user equipment to perform at least the following: detecting a RLF of a radio link between the first user equipment and the radio access node; suspending initiation of radio resource control connection recovery; receiving, from the first user equipment, a message indicative of successful radio resource control connection reestablishment or failed radio resource control connection reestablishment; and resuming the detection of the RLF when the message indicates the successful radio resource control connection reestablishment.

According to another embodiment, an user equipment comprises: a radio interface via which the user equipment can have a radio link with a radio access node; a device-to-device interface via which the user equipment can have a device-to-device radio link with another user equipment; a detection module configured to detect a RLF of the radio link; an informing module configured to, in the case that the user equipment is linked with the radio access node and another user equipment which communicates with the radio access node via the user equipment, inform another user equipment to suspend a radio resource control connection state upon detection of the RLF, and to inform another user equipment to resume the radio resource control connection state when a radio resource control connection reestablishment is successful; an execution module configured to execute a radio resource control connection reestablishment procedure with the radio access node; a receiving module configured to, in the case that the user equipment is linked with another user equipment which has a radio link with the radio access node, receive a first message indicative of suspending a radio resource control connection state from another user equipment, and to receive a second message indicative of resuming the radio resource control connection state or successful radio resource control connection reestablishment from another user equipment; a suspension module configured to suspend the radio resource control connection state upon receipt of the first message, or to suspend initiation of radio resource control connection recovery upon detection of the RLF; and a resuming module configured to resume the radio resource control connection state when the second message indicates resuming the radio resource control connection state, and to resume the detection of the RLF when the second message indicates the successful radio resource control connection reestablishment.

In an exemplary embodiment, the informing module is further configured to inform another user equipment of the radio resource control connection reestablishment failure.

In an exemplary embodiment, the informing module may comprise: a sending unit configured to send a third message indicative of suspending timers and counters related to RLF, and to send a fourth message indicative of resuming the suspended timers and counters.

In an exemplary embodiment, the suspension module may be configured to suspend timers and counters related to RLF.

In an exemplary embodiment, the resuming module may be configured to resume the suspended timers and counters.

In an exemplary embodiment, the user equipment may further comprise: a setting module configured to set a suspension timer which defines a time period for suspension of the initiation of radio resource control connection recovery.

According to another embodiment, a computer program product including one or more sequences of one or more instructions which, when executed by one or more processors, cause an apparatus to at least perform the steps of a method for radio resource control connection recovery.

According to another embodiment, a computer program product including one or more sequences of one or more instructions which, when executed by one or more processors, cause an apparatus to at least perform the steps of a method used with radio resource control connection recovery.

According to another embodiment, an apparatus for radio resource control connection recovery comprises: means for detecting a RLF of a radio link between a first user equipment and a radio access node; means for informing a second user equipment which communicates with the radio access node via the first user equipment to suspend a radio resource control connection state; means for executing a radio resource control connection reestablishment procedure with the radio access node; and means for informing the second user equipment to resume the radio resource control connection state if the radio resource control connection reestablishment is successful.

According to another embodiment, an apparatus used with radio resource control connection recovery by a second user equipment which communicates with a radio access node via a first user equipment comprises: means for receiving, from the first user equipment which has a radio link with the radio access node, a first message indicative of suspending a radio resource control connection state; means for suspending the radio resource control connection state; means for receiving, from the first user equipment, a second message indicative of resuming the radio resource control connection state or radio resource control connection reestablishment failure; and means for resuming the radio resource control connection state when the second message indicates resuming the radio resource control connection state.

According to another embodiment, an apparatus used with radio resource control connection recovery by a second user equipment which communicates with a radio access node via a first user equipment comprises: means for detecting a RLF of a radio link between the first user equipment and the radio access node; means for suspending initiation of radio resource control connection recovery; means for receiving, from the first user equipment, a message indicative of successful radio resource control connection reestablishment or failed radio resource control connection reestablishment; and means for resuming the detection of the RLF when the message indicates the successful radio resource control connection reestablishment.

Generally, all terms used in this specification are to be interpreted according to their ordinary meaning in the technical field, unless explicitly defined otherwise herein. All references to “a/an/the [element, device, apparatus, component, means, step, etc]” are to be interpreted openly as referring to at least one instance of said element, device, apparatus, component, means, step, etc., unless explicitly stated otherwise. The steps of any method disclosed herein do not have to be performed in the exact order disclosed, unless explicitly stated.

Those skilled in the art will appreciate that the above is merely an introduction to the subject matter described in more detail below. Other objectives, features and advantages of the present invention will appear from the following detailed disclosure, from the attached dependent claims as well as from the drawings.

### BRIEF DESCRIPTION OF THE DRAWINGS

A more complete understanding of the present invention and certain advantages thereof may be acquired by referring to the following description in consideration of the accompanying drawings, in which like reference numbers indicate like features, and wherein:

FIG. 1 illustratively shows an exemplary scenario in which the relayed UE relies on the relaying UE to establish RRC connection with the eNodeB;

FIG. 2 illustratively shows protocol stacks of the relayed UE, the relaying UE and the eNodeB;

FIG. 3 shows a schematic diagram illustrating the existing RLF handling procedure;

FIG. 4 is a flow chart illustrating the method for radio resource control connection recovery according to an exemplary embodiment of the present invention;

FIG. 5 is a flow chart illustrating the method used with radio resource control connection recovery according to an exemplary embodiment of the present invention;

FIG. 6 is a signal chart illustrating the RRC connection recovery procedure in which the methods shown in FIGS. 4 and 5 are implemented in the scenario of FIG. 1;

FIG. 7 is a flow chart illustrating the method used with radio resource control connection recovery according to another exemplary embodiment of the present invention;

FIG. 8 is a signal chart illustrating the RRC connection recovery procedure in which the method shown in FIG. 7 is implemented in the scenario of FIG. 1;

FIG. 9 is a schematic block diagram illustrating the first user equipment for radio resource control connection recovery according to an exemplary embodiment of the present invention;

FIG. 10 is a schematic block diagram illustrating the second user equipment used with radio resource control connection recovery according to an exemplary embodiment of the present invention;

FIG. 11 is a schematic block diagram illustrating the user equipment according to an exemplary embodiment of the present invention.

### DETAILED DESCRIPTION OF THE EMBODIMENTS

In the following description of the various illustrative embodiments, reference is made to the accompanying drawings, which form a part thereof, and in which are shown by way of illustration various exemplary embodiments in which the invention may be practiced. It is to be understood that other embodiments may be utilized and structural and functional modifications may be made without departing from the scope of the present invention.

FIG. 4 is a flow chart illustrating the method for radio resource control connection recovery according to an exemplary embodiment of the present invention. This embodiment will be described in detail in conjunction with the figure.

As shown in FIG. 4, at step S410, a first user equipment detects a RLF of a radio link between the first user equipment and a radio access node. The first user equipment is under control of the radio access node, and has a radio resource control connection with the radio access node. The radio resource control connection is supported by the radio link between the first user equipment and the radio access node. In this embodiment, the radio link can be a cellular radio link. For example, the radio link may be a LTE radio link, and the radio access node may be an eNodeB in a LTE communication system. It would be appreciated for a person skilled in the art that the radio link can be based on other cellular radio access technologies, such as LTE-Advanced technology or any 4G communication technology.

In this embodiment, the first user equipment can detect signal quality over the radio link. When the first user equipment detects that the signal quality becomes lower than a predetermined threshold, it determines that there is a radio problem on the radio link. Then the first user equipment can start a timer of T₁ and check whether the radio link can be recovered before the timer expires. If the radio link is recovered before the timer expires, the first user equipment continues detecting the signal quality. If the radio link is not recovered before the timer expires, the first user equipment determines that the RLF happens over the radio link.

Then at step S420, the first user equipment informs a second user equipment which communicates with the radio access node via the first user equipment to suspend a radio resource control connection state of the second user equipment.

In this embodiment, a device-to-device radio link can be set up between the first user equipment and the second user equipment. The device-to-device radio link may be cellular based, such as LTE based or LTE-Advanced based or any other cellular radio access technology based, or non-cellular based, such as WiFi based, Bluetooth based, WiFi Direct based or any other non-cellular radio access technology based. The second user equipment can have a radio resource control connection with the radio access node over the device-to-device radio link between the second user equipment and the first user equipment and the radio link between the first user equipment and the radio access node.

The first user equipment may send a first message indicative of suspending timers and counters related to RLF to the second user equipment to main the radio resource control connection with the radio access node of the second user equipment. The first message may be a signaling message transmitted over the device-to-device radio link, and may include an indication of suspending the timers and counters, an identifier of the second user equipment, and parameters for signaling message encapsulation.

Then at step S430, the first user equipment executes the radio resource control connection reestablishment procedure with the radio access node. For example, the first user equipment can send a RRC Connection Reestablishment Request to the radio access node, and then the radio access node can send a RRC Connection Reestablishment message to the first user equipment to update related parameters of signaling radio bearers, and after updating all the parameters, the first user equipment can send a RRC Connection Reestablishment Complete message to the radio access node. Thus the radio resource control connection reestablishment is successful.

Although it is described that the step S420 is prior to the step S430 in this embodiment, the step S430 may be prior to the step S420, or the steps S420 and S430 can be performed concurrently.

At step S440, if the radio resource control connection reestablishment is successful, the first user equipment informs the second user equipment to resume the radio resource control connection state. The first user equipment may send a second message indicative of resuming the suspended timers and counters. The second message may be a signaling message transmitted over the device-to-device radio link, and may include an indication of resuming the timers and counters, the identifier of the second user equipment, and parameters for signaling message encapsulation.

In case that the radio resource control connection reestablishment fails, both radio resource control connections for the first and second user equipments will be broken. The first user equipment will inform the second user equipment of the radio resource control connection reestablishment failure. Thus the second user equipment stops trying the radio resource control connection recovery via the first user equipment.

It can be seen from the above description that with the method of this embodiment, when the RLF happens on the radio link, the first user equipment can inform the second user equipment to suspend the radio resource control connection state while executing the radio resource control connection reestablishment procedure, so that the second user equipment will not trigger the radio resource control connection recovery procedure, thereby avoiding unnecessary signaling cost and latency.

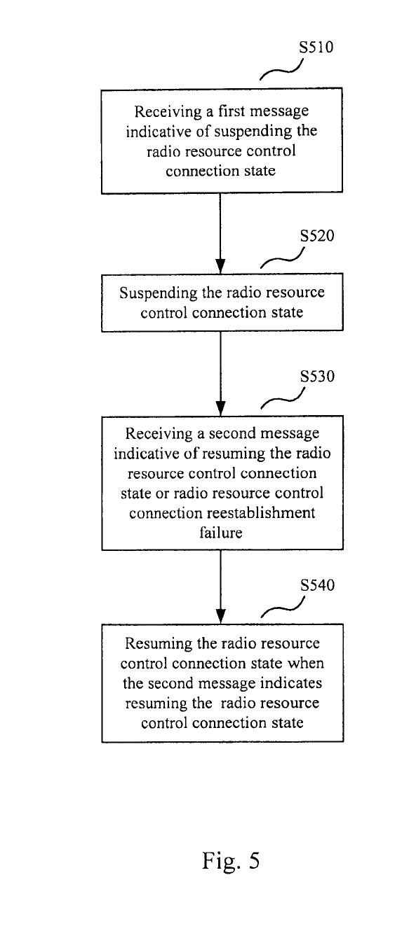

FIG. 5 is a flow chart illustrating the method used with radio resource control connection recovery according to an exemplary embodiment of the present invention. This embodiment will be described in detail in conjunction with the figure. For the parts which are same as those of the previous embodiment, the description thereof will be omitted properly.

The method of this embodiment can be performed by the second use equipment. In this embodiment, the second user equipment has the device-to-device radio link with the first user equipment which has the radio link with the radio access node. Both the first and second user equipments have the radio resource control connections with the radio access node. As described above, the radio resource control connection between the first user equipment and the radio access node is supported by the radio link, and the radio resource control connection between the second user equipment and the radio access node is supported by the device-to-device radio link and the radio link.

As shown in FIG. 5, at step S510, the second user equipment receives from the first user equipment a first message indicative of suspending the radio resource control connection state of the second user equipment. The first message may be a signaling message over the device-to-device radio link, and may include the indication of suspending the radio resource control connection state, the identifier of the second user equipment, and the parameters for signaling message encapsulation.

Upon receipt of the first message, at step S520, the second user equipment suspends its radio resource control connection state. The second use equipment may suspend the timers and counters related to RLF, and would not trigger the radio resource control connection recovery.

Then at step S530, the second user equipment receives from the first user equipment a second message indicative of resuming the radio resource control connection state or radio resource control connection reestablishment failure. The second message may be a signaling message over the device-to-device radio link, and may include the indication of resuming the radio resource control connection state or the radio resource control connection reestablishment failure, the identifier of the second user equipment and the parameters for signaling message encapsulation.

When the received second message indicates resuming the radio resource control connection state, at step S540, the second user equipment resumes the radio resource control connection state. The second user equipment may resume the timers and counters suspended at step S520.

When the received second message indicates the failure of the radio resource control connection reestablishment, the second user equipment will stop trying the radio resource control connection recovery.

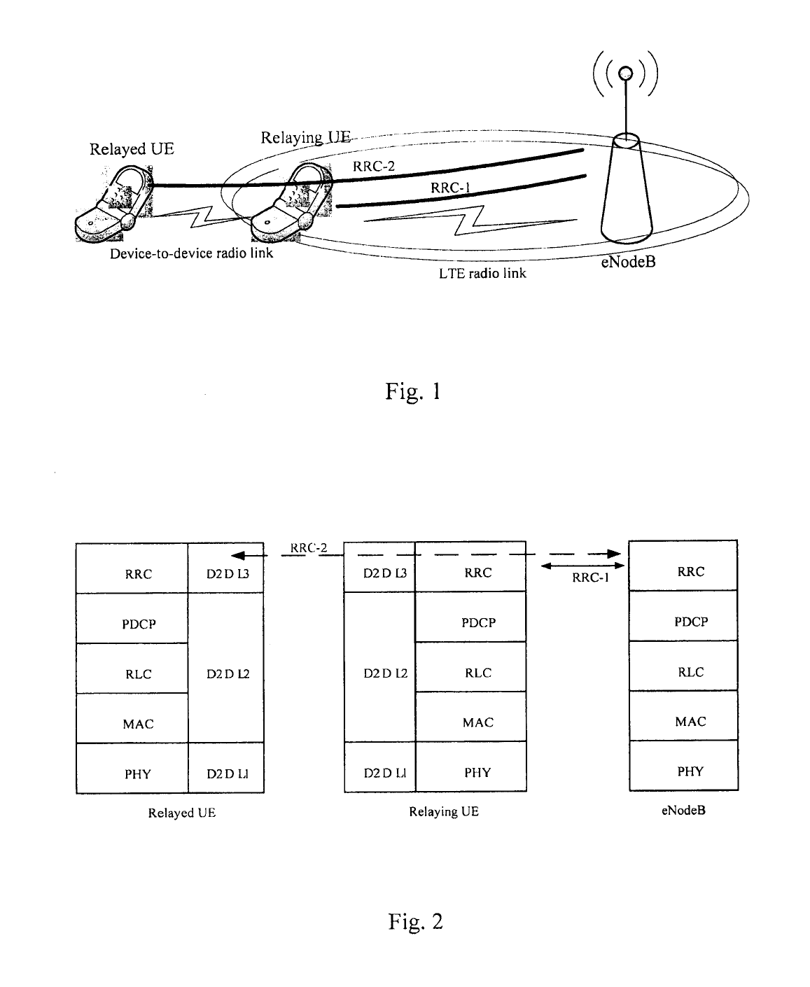

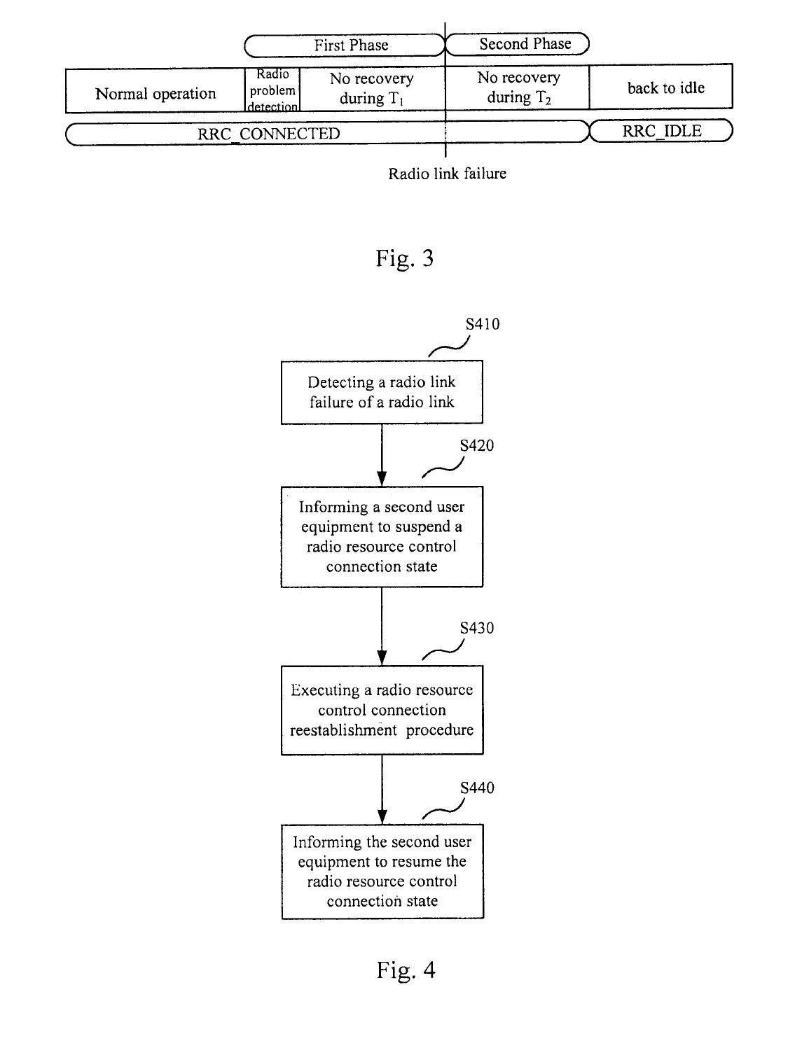

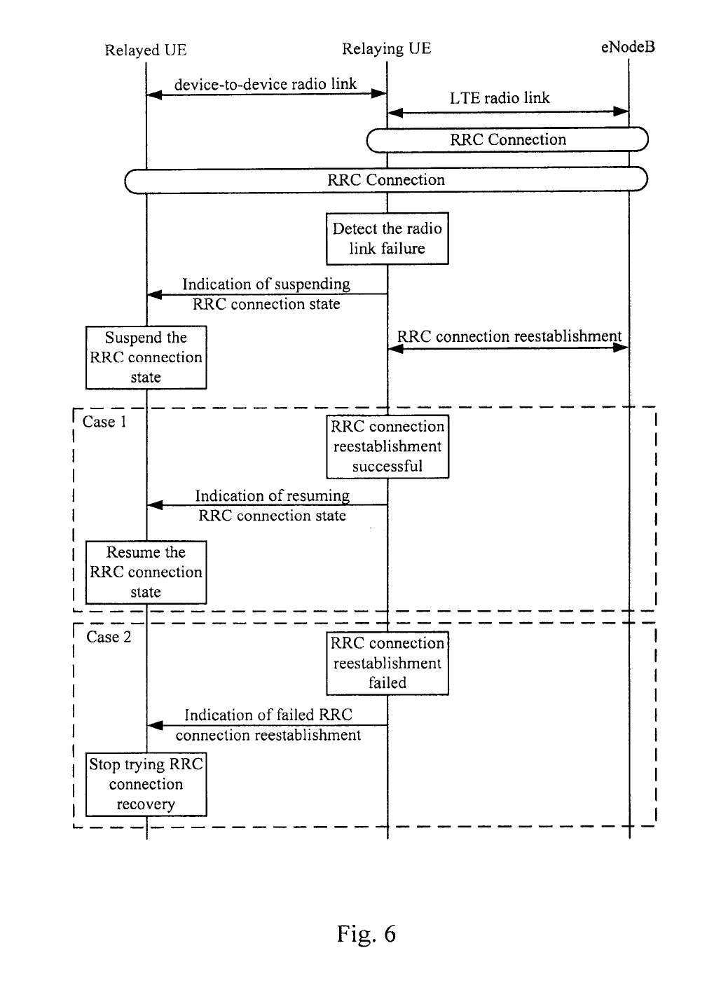

The methods of the above described embodiments shown in FIGS. 4 and 5 can be applied to the exemplary scenario shown in FIG. 1. In this case, the first user equipment is the relaying UE, the second user equipment is the relayed UE, and the radio access node is the eNodeB which serves the relaying UE. FIG. 6 shows the signal chart illustrating the RRC connection recovery procedure in the scenario of FIG. 1.

As shown in FIG. 6, there is the device-to-device radio link between the relayed UE and the relaying UE, and there is the LTE radio link between the relaying UE and the eNodeB. Both the relayed UE and the relaying UE have the RRC connections with the eNodeB.

The relaying UE detects the RLF of the LTE radio link, and then it informs the relayed UE in the first message to suspend the RRC connection state. The relayed UE receives the first message and suspends its RRC connection state, without triggering the RRC connection recovery. Meanwhile, the relaying UE executes the RRC connection reestablishment with the eNodeB. After the RRC connection reestablishment is successful, the relaying UE informs the relayed UE in the second message to resume the RRC connection state. The relayed UE receives the second message and resumes the RRC connection state. If the RRC connection reestablishment is failed, the relaying UE informs the relayed UE of the RRC connection reestablishment failure. The relayed UE will stop trying the RRC connection recovery.

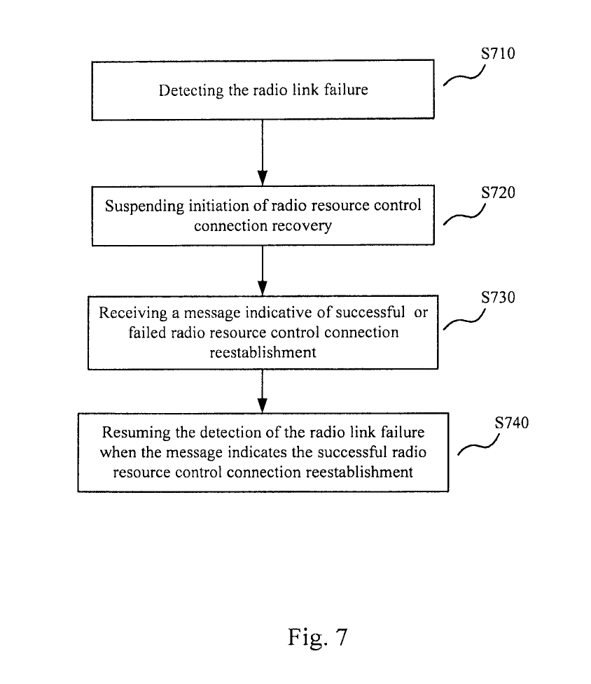

FIG. 7 is a flow chart illustrating the method used with radio resource control connection recovery according to another exemplary embodiment of the present invention. The method of this embodiment can be performed by the second use equipment. This embodiment will be described in detail in conjunction with the figure. For the parts which are same as those of the previous embodiment, the description thereof will be omitted properly.

In this embodiment, the second user equipment has the device-to-device radio link with the first user equipment which has the radio link with the radio access node. Both the first and second user equipments have the radio resource control connections with the radio access node. As described above, the radio resource control connection between the first user equipment and the radio access node is supported by the radio link, and the radio resource control connection between the second user equipment and the radio access node is supported by the device-to-device radio link and the radio link.

As shown in FIG. 7, at step S710, the second user equipment detects the RLF of the radio link between the first user equipment and the radio access node. In this embodiment, since the radio resource control connection between the second user equipment and the radio access node is over the device-to-device radio link and the radio link, the second user equipment cannot directly detect the RLF of the radio link. So the second user equipment may utilize related messages or parameters on layers above physical layer to detect the RLF. For example, the second user equipment may check the number of retransmission. When the number of retransmission exceeds a retransmission threshold and the device-to-device radio link works properly, the second user equipment can determine the RLF.

Upon detection of the RLF, at step S720, the second user equipment suspends initiation of radio resource control connection recovery, i.e. the second user equipment would not trigger the radio resource control connection recovery. Optionally, the second user equipment may set a suspension timer which defines a time period for suspension. The time period may be longer than the time period necessary for the radio resource control connection reestablishment procedure.

Then at step S730, the second user equipment receives from the first user equipment a message indicative of successful radio resource control connection reestablishment or failed radio resource control connection reestablishment. If the message indicates the successful radio resource control connection reestablishment, at step S740, the radio resource control connection between the second user equipment and the radio access node can be kept, and the second user equipment resumes the detection of the RLF. If the message indicates the failed radio resource control connection reestablishment, both the radio resource control connections for the first and second user equipment will be broken, and the second user equipment will stop trying the radio resource control connection recovery.

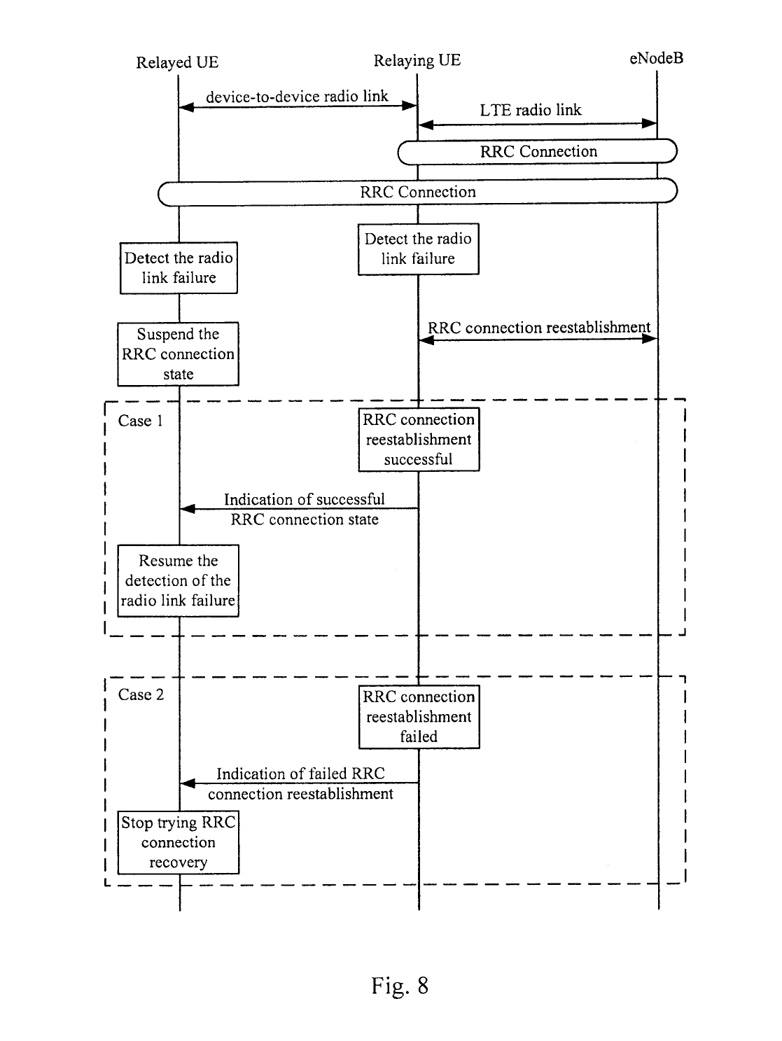

The method of this embodiment may also be applied to the exemplary scenario shown in FIG. 1. In this case, the first user equipment is the relaying UE, the second user equipment is the relayed UE, and the radio access node is the eNodeB which serves the relaying UE. FIG. 8 shows the signal chart illustrating the RRC connection recovery procedure in the scenario of FIG. 1.

As shown in FIG. 8, the relaying UE and the relayed UE detect the RLF respectively. Then the relayed UE suspends the initiation of the RRC connection recovery, and optionally starts the suspension timer. The relaying UE executes the RRC connection reestablishment with the eNodeB. When the RRC connection reestablishment is successful, the relaying UE informs the relayed UE in a message of the successful RRC connection reestablishment. The relayed UE receives the message and resumes the detection of the RLF. If the RRC connection reestablishment is failed, the relaying UE informs the relayed UE in the message of the failed RRC connection reestablishment. The relayed UE will stop trying the RRC connection recovery.

Although the above embodiments of the methods are described for the LTE communication system, a person skilled in the art would appreciate that these embodiments can also be applied to other radio communication system, such as LTE-A communication system or other 4G communication system.

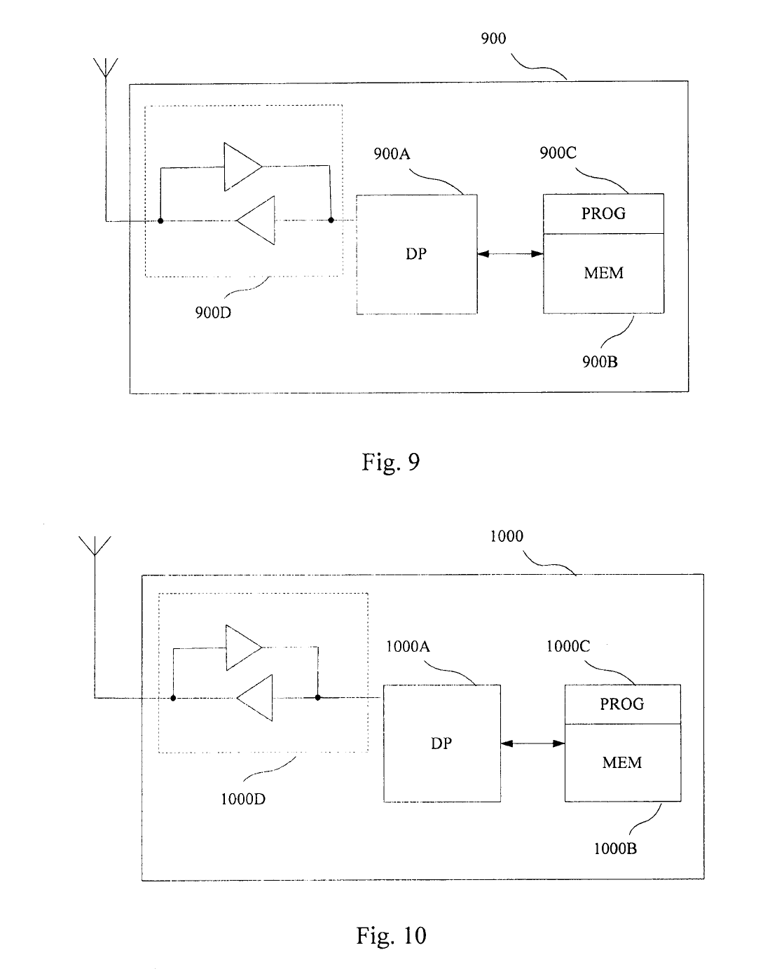

FIG. 9 is a schematic block diagram illustrating the first user equipment 900 for radio resource control connection recovery according to an exemplary embodiment of the present invention. In FIG. 9, the first user equipment 900 may comprise a data processor (DP) 900A, a memory (MEM) 900B that stores a program (PROG) 900C, a transceiver 900D and an antenna.

At least one of the PROG 900C is assumed to comprise program instructions that, when executed by the associated DP 900A, enable the first user equipment 900 to operate in accordance with the exemplary embodiment of the method shown in FIG. 4, as discussed above. That is, the exemplary embodiment of the method shown in FIG. 4 may be implemented at least in part by computer software executable by the DP 900A of the first user equipment 900, or by hardware, or by a combination of software and hardware.

FIG. 10 is a schematic block diagram illustrating the second user equipment 1000 used with radio resource control connection recovery according to an exemplary embodiment of the present invention. In FIG. 10, the second user equipment 1000 may comprise a data processor (DP) 1000A, a memory (MEM) 1000B that stores a program (PROG) 1000C, a transceiver 1000D and an antenna.

At least one of the PROG 1000C is assumed to comprise program instructions that, when executed by the associated DP 1000A, enable the second user equipment 1000 to operate in accordance with the exemplary embodiment of the method shown in FIG. 5, as discussed above. That is, the exemplary embodiment of the method shown in FIG. 5 may be implemented at least in part by computer software executable by the DP 1000A of the second user equipment 1000, or by hardware, or by a combination of software and hardware.

Also, the program instructions can enable the second user equipment 1000 to operate in accordance with the exemplary embodiment of the method shown in FIG. 7.

The MEM 900B, 1000B may be of any type suitable to the local technical environment and may be implemented using any suitable data storage technology, such as semiconductor based memory devices, flash memory, magnetic memory devices and systems, optical memory devices and systems, fixed memory and removable memory. The DP 900A, 1000A may be of any type suitable to the local technical environment, and may comprise one or more of general purpose computers, special purpose computers, microprocessors, digital signal processors (DSPs) and processors based on multi-core processor architectures, as non-limiting examples.

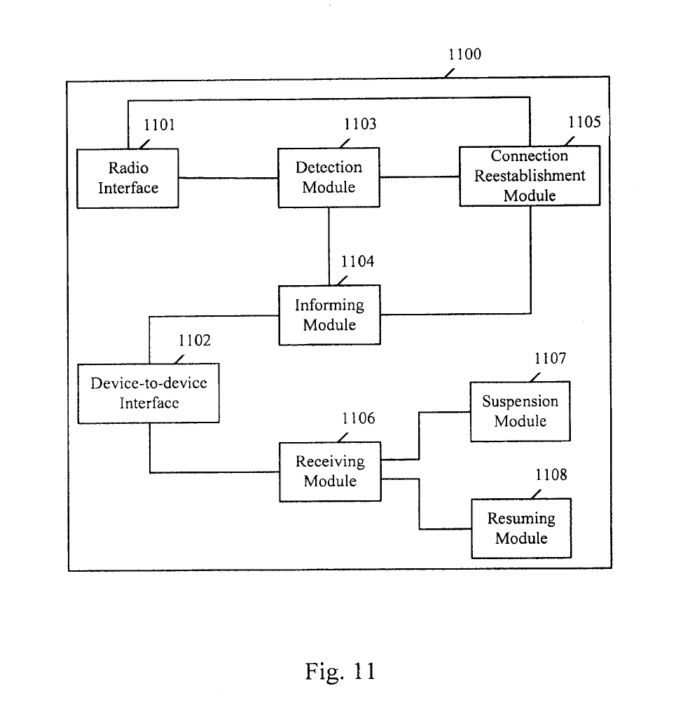

FIG. 11 is a schematic block diagram illustrating the user equipment 1100 according to an exemplary embodiment of the present invention. This embodiment will be described in detail in conjunction with the figure. For the parts which are same as those of the previous embodiment, the description thereof will be omitted properly.

As shown in FIG. 11, the user equipment 1100 comprises: a radio interface 1101, a device-to-device interface 1102, a detection module 1103, an informing module 1104, a connection reestablishment module 1105, a receiving module 1106, a suspension module 1107, and a resuming module 1108.

The user equipment 1100 can have the radio link with a radio access node via the radio interface 1101 and can have a device-to-device radio link with another user equipment via the device-to-device interface 1102. The radio interface 1101 may be based on cellular radio access technologies. For example, the radio interface 1101 may be Uu interface in LTE network. The device-to-device interface 1102 may be based on non-cellular radio access technologies. For example, the device-to-device interface 1102 may be WiFi interface, Bluetooth interface, or WiFi Direct interface.

The detection module 1103 can detect the RLF of the radio link. In the case that the user equipment 1100 is linked with the radio access node via the radio interface 1101 and another user equipment via the device-to-device interface 1102, and another user equipment communicates with the radio access node via the user equipment 1100, that is, the user equipment 1100 is used as the relaying UE and anther user equipment is used as the relayed UE, the detection module 1103 will detect the RLF of the radio link between the user equipment 1100 and the radio access node. In the case that the user equipment 1100 is linked with another user equipment via the device-to-device interface 1102 and another user equipment has a radio link with the radio access node, that is, the user equipment 1100 is used as the relayed UE and another user equipment is used as the relaying UE, the detection module 1103 will detect the RLF of the radio link between another user equipment and the radio access node.

In the case that the user equipment 1100 is used as the relaying UE, upon the detection module 1103 detects the RLF, the informing module 1104 can inform another user equipment to suspend its radio resource control connection state. In an embodiment, the informing module 1104 may comprise a sending unit which sends a third message indicative of suspending timers and counters related to RLF. Meanwhile, the connection reestablishment module 1105 can execute the radio resource control connection reestablishment procedure with the radio access node. When the radio resource control connection reestablishment is successful, the informing module 1104 can inform another user equipment to resume the radio resource control connection state. In an embodiment, the sending unit may send a fourth message indicative of resuming the suspended timers and counters. When the radio resource control connection reestablishment is failed, the informing module 1104 can inform another user equipment of the radio resource control connection reestablishment failure.

In the case that the user equipment 1100 is used as the relayed UE, the receiving module 1106 can receive a first message indicative of suspending the radio resource control connection state from another user equipment used as the relaying UE. In this case, the suspension module 1107 can suspend the radio resource control connection state. In an embodiment, the suspension module 1107 suspends the timers and counters related to RLF. When the receiving module 1106 receive a second message indicative of resuming the radio resource control connection state, the resuming module 1108 can resume the radio resource control connection. In another embodiment, the receiving module 1106 may not receive the first message from anther user equipment. In this case, the suspension module 1107 may suspend initiation of radio resource control connection recovery when the detection module 1103 detects the RLF of the radio link between another user equipment and the radio access node. Then the receiving module 1106 can receive a second message indicative of successful or failed radio resource control connection reestablishment. When the second message indicates the successful radio resource control connection reestablishment, the resuming module 1108 can resume the detection of the RLF. When the second message indicates the failure of the radio resource control connection reestablishment, the user equipment 1100 would stop trying radio resource control connection recovery.

Optionally, the user equipment 1100 may comprise a setting module, which sets a suspension timer which defines a time period for suspension of the initiation of radio resource control connection recovery.

It should be noted that the user equipment 1100 can be used as the relaying UE or the relayed UE, and can implement the methods of the embodiments shown in FIGS. 4, 5 and 7.

Alternatively or optionally, according to an exemplary embodiment of the invention, an apparatus for radio resource control connection recovery is provided, which comprises: means for detecting a RLF of a radio link between a first user equipment and a radio access node; means for informing a second user equipment which communicates with the radio access node via the first user equipment to suspend a radio resource control connection state; means for executing a radio resource control connection reestablishment procedure with the radio access node; and means for informing the second user equipment to resume the radio resource control connection state if the radio resource control connection reestablishment is successful.

Alternatively or optionally, according to an exemplary embodiment of the invention, an apparatus used with radio resource control connection recovery by a second user equipment which communicates with a radio access node via a first user equipment is provided, which comprises: means for receiving, from the first user equipment which has a radio link with the radio access node, a first message indicative of suspending a radio resource control connection state; means for suspending the radio resource control connection state; means for receiving, from the first user equipment, a second message indicative of resuming the radio resource control connection state or radio resource control connection reestablishment failure; and means for resuming the radio resource control connection state when the second message indicates resuming the radio resource control connection state.

Alternatively or optionally, according to an exemplary embodiment of the invention, an apparatus used with radio resource control connection recovery by a second user equipment which communicates with a radio access node via a first user equipment is provided, which comprises: means for detecting a RLF of a radio link between the first user equipment and the radio access node; means for suspending initiation of radio resource control connection recovery; means for receiving, from the first user equipment, a message indicative of successful radio resource control connection reestablishment or failed radio resource control connection reestablishment; and means for resuming the detection of the RLF when the message indicates the successful radio resource control connection reestablishment.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the invention may be practiced in various components such as integrated circuit chips and modules. It should thus be appreciated that the exemplary embodiments of this invention may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this invention.

It should be appreciated that at least some aspects of the exemplary embodiments of the inventions may be embodied in computer-executable instructions, such as in one or more program modules, executed by one or more computers or other devices. Generally, program modules comprise routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by those skilled in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

The present invention comprises any novel feature or combination of features disclosed herein either explicitly or any generalization thereof. Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

1-40. (canceled)

41. A first user equipment, comprising:
at least one processor; and
at least one memory including computer program code;
the at least one memory and the computer program code configured to, with the at least one processor, cause the first user equipment to perform at least the following:
detect a radio link failure of a radio link between the first user equipment and a radio access node;
inform a second user equipment which communicates with the radio access node via the first user equipment to suspend a radio resource control connection state;
execute a radio resource control connection reestablishment procedure with the radio access node; and
inform the second user equipment to resume the radio resource control connection state if the radio resource control connection reestablishment is successful.

42. The first user equipment according to claim 41, wherein the at least one memory and the computer program code are configured to, with the at least one processor, cause the first user equipment to further perform the following:
inform the second user equipment of the radio resource control connection reestablishment failure if the radio resource control connection reestablishment fails.

43. The first user equipment according to claim 41, wherein the at least one memory and the computer program code are configured to, with the at least one processor, cause the first user equipment to inform the second user equipment to suspend a radio link connection state by:
sending, to the second user equipment, a first message indicative of suspending timers and counters related to radio link failure.

44. The first user equipment according to claim 43, wherein the at least one memory and the computer program code are configured to, with the at least one processor, cause the first user equipment to inform the second user equipment to resume the radio resource control connection state by:
sending, to the second user equipment, a second message indicative of resuming the suspended timers and counters.

45. The first user equipment according to claim 41, wherein the radio link is a cellular radio link, and the first user equipment has a device-to-device radio link with the second user equipment.

46. The first user equipment according to claim 45, wherein the device-to-device radio link is cellular based or non-cellular based.

47. A second user equipment used with radio resource control connection recovery, the second user equipment communicating with a radio access node via a first user equipment, comprising:
at least one processor; and
at least one memory including computer program code;
the at least one memory and the computer program code configured to, with the at least one processor, cause the second user equipment to perform at least the following:
receive, from the first user equipment which has a radio link with the radio access node, a first message indicative of suspending a radio resource control connection state;
suspend the radio resource control connection state;
receive, from the first user equipment, a second message indicative of resuming the radio resource control connection state or radio resource control connection reestablishment failure; and
resume the radio resource control connection state when the second message indicates resuming the radio resource control connection state.

48. The second user equipment according to claim 47, wherein the at least one memory and the computer program code are configured to, with the at least one processor, cause the second user equipment to suspend the radio resource control connection state by:
suspending timers and counters related to radio link failure.

49. The second user equipment according to claim 48, wherein the at least one memory and the computer program code are configured to, with the at least one processor, cause the second user equipment to resume the radio resource control connection state by:
resuming the suspended timers and counters.

50. The second user equipment according to claim 47, wherein the radio link is a cellular radio link, and the second user equipment has a device-to-device radio link with the first user equipment.

51. The second user equipment according to claim 50, wherein the device-to-device radio link is cellular based or non-cellular based.

52. A second user equipment used with radio resource control connection recovery, the second user equipment communicating with a radio access node via a first user equipment, comprising:
at least one processor; and
at least one memory including computer program code;
the at least one memory and the computer program code configured to, with the at least one processor, cause the second user equipment to perform at least the following:
detect a radio link failure of a radio link between the first user equipment and the radio access node;
suspend initiation of radio resource control connection recovery;
receive, from the first user equipment, a message indicative of successful radio resource control connection reestablishment or failed radio resource control connection reestablishment; and
resume the detection of the radio link failure when the message indicates the successful radio resource control connection reestablishment.

53. The second user equipment according to claim 52, wherein the at least one memory and the computer program code are configured to, with the at least one processor, cause the second user equipment to further perform the following:
set a suspension timer which defines a time period for suspension of the initiation of radio resource control connection recovery.

54. The second user equipment according to claim 52, wherein the radio link is a cellular radio link, and the second user equipment has a device-to-device radio link with the first user equipment.

55. The second user equipment according to claim 54, wherein the device-to-device radio link is cellular based or non-cellular based.
